(19) United States
(12) Patent Application Publication
(10) Pub. No.: US 2025/0129280 A1
(43) Pub. Date: Apr. 24, 2025

(54) ICE RELEASE

(71) Applicant: Molly Busby, Midland, MI (US)

(72) Inventor: Molly Busby, Midland, MI (US)

(21) Appl. No.: 18/920,049

(22) Filed: Oct. 18, 2024

Related U.S. Application Data
(60) Provisional application No. 63/591,459, filed on Oct. 19, 2023.

(51) Int. Cl. C09K 3/18

(52) U.S. Cl. CPC C09K 3/185

(57) ABSTRACT

An ice release formulation that is useful on any solid surface to allow ice to be almost immediately removed. The formulation is highly hydrophobic and will not allow water to remain on it. In addition, if water turns to ice, the ice is easily removed without the use of instruments or tools as the ice releases by itself to leave the substrate

### TO WHOM IT MAY CONCERN

Be it known that I, Molly Busby, a resident of the City of Midland, County of Midland, and the State of Michigan, a United States of America citizen have invented a new and novel ICE RELEASE the following of which is a specification therefor.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

This application deals with an ice release formulation that is useful on any solid surface to allow ice to be almost immediately removed. The formulation is highly hydrophobic and will not allow water to rest on it. In addition, if water turns to ice, the ice is easily removed without the use of instruments or tools as the ice releases by itself to leave the substrate.

### BRIEF SUMMARY OF THE INVENTION

What is disclosed and claimed herein is an ice release formulation comprising a nonionic polydimethylsiloxane fluid having a viscosity in the range of 100 cps to 10,000 cps at 25° C., an organic wax, water, and a surfactant.

In another embodiment, there is disclosed and claimed herein an ice release as stated just Supra in which two or more surfactants are used.

### BRIEF DESCRIPTION OF THE SEVERAL VIEWS OF THE DRAWING(S)

Not Applicable.

### DETAILED DESCRIPTION OF THE INVENTION

Thus, there is an ice release formulation comprising a nonionic polydimethylsiloxane fluid having a viscosity in the range of 100 cps to 10,000 cps at 25° C. (5,000 to 38,000 grams/mole), an organic wax, water, and a surfactant.

The polydimethylsiloxane fluid is trimethyl-endblocked and therefore, not reactive in the usual sense.

The wax used in the examples herein is carnauba wax, but any hard wax can be used as long as it can be emulsified. As used herein, the wax is emulsified as received from the supplier.

The surfactants used herein are intended to allow emulsification of a combination of hard wax and the polydimethylsiloxane.

The percentage of components in water is from 10 weight percent to 90 percent.

There is a second embodiment and that is an ice release as stated just Supra in which two or more surfactants are used. Sometimes, the emulsion of the combination of the wax and siloxane requires the use of two or more surfactants.

Surfactants found useful in this application are Xiameter OFX-5211 fluid which is a low molecular weight nonionic silicone polyether surfactant manufactured by the silicones division of the Dow Chemical Company, Midland, Michigan, Tergitol 15-S-3 and Tergitol 15-S-9. Tergitol is a registered trademark of Dow Chemical, Midland, Michigan.

Sometimes a thickener is useful in this formulation to stabilize the emulsion and such thickeners can be for example, Methocel® sold by the Dupont company.

Tergitol 15-S-3 and Tergitol 15-S-9 are registered tradenames of the Dow Chemical Company, Midland, Michigan.

Sometimes, it is desired to use a preservative in the emulsion as emulsions are susceptible to invasion of bacteria and render the formulation useless. Kathon LN has been used in the examples.

The final emulsion form of the material is quite stable, having emulsion stability for several months.

As indicated in the examples, the formulation is preferred to be in an emulsion form. The ingredients can be combined in any order desired, except for Methocel which requires a longer dissolution time and should be dissolved in water first.

The separate components can be pre-emulsified and then combined, or they can be combined and then emulsified.

The final composition is a milky white, low viscosity, fluid.

It can be applied to any solid substrate such as airplane wings, space vehicle surfaces, ships, large equipment, roofs, either metal or shingle, electrical wires, cables, and the like.

Type of application used is one which best fits the surface to be coated and can consist of painting, spraying, misting, pouring and the like. The material has a tendency to stick to the substrate without a covalent bonding type of adhesion. Sustainability of adhesion depends on the substrate, the weather, and the end use of the substrate. Static large equipment, for example, will allow for weeks of sustained use, while airplane wings that are subjected to travel will not sustain for a long time.

As indicated by the surfactants previously mentioned the surfactant is present within the formulation from 0.01 to 2.0 weight percent depending on the amount of polydimethylsiloxane and wax present.

Where there are two surfactants present the weight percent remains 0.01 to 2.0 percent weight based on the amount of polydimethylsiloxane and wax present.

### EXAMPLES

### Example 1

In a glass beaker, there was combined 160 grams of trimethylsiloxyendblocked polydimethylsiloxane polymer emulsion having a molecular weight of 5,000 g/mole (63 weight % solids); 4 grams of OFX-5211 silicone glycol fluid surfactant (Dow Chemical, silicones Division, Midland, Michigan); 1000 grams of carnauba wax emulsion (32 weight percent solids), and 2800 grams of water and the mixture was stirred with a small mixer for 60 minutes. There was then added 13.33 grams of Kathon LX 1.5% preservative and the mixture was stirred for an additional 60 minutes. The resulting composition was a milky white emulsion having a low viscosity.

An aluminum panel was coated one side with this mixture using a draw down bar. The coated panel was allowed to air dry for about 30 minutes. Two inches of the coated panel at the top was bent at a 35° angle and placed in a low temperature freezer at −80° C. After about 15 minutes the panel was removed from the freezer and the surface of the panel was treated with a small stream of water which froze instantly. After about one minute, the panel was raised slightly from the bent end and all of the ice that had formed slid off the panel.

### Example 2

In a glass beaker, there was combined 160 grams of the trimethylsiloxyendblocked polydimethylsiloxane polymer; 4 grams of OFX-5211 silicone glycol surfactant; 1000 grams of carnauba wax emulsion; 2800 grams of water, and 40 grams of Tergitol 15-S-3 as a second surfactant, and 3 grams of Methocel K15M (gel) and the mixture was stirred with a small mixer for 120 minutes. Thereafter, 13.33 grams of Kathon LX 1.5% was added to make 50 ppm and the combination was mixed for an additional 30 minutes.

The panel was subjected to the test as set forth Supra and the ice slid off the panel within seconds.

The Xiameter OFX-5211 fluid is manufactured by the silicones division of the Dow Chemical Company, Midland, Michigan.

Michem Lube 743 is supplied by Michelman, Inc. Cincinnati, Ohio; CHT 1670 The silicone emulsion is supplied by CHT, USA, Cassopolis, Michigan; The weight of the molecular polydimethylsiloxane polymer ranges from 5,000 g/mole to 38,000 g/mole and has a viscosity of 100 cps to 10,000 cps at 25° C.

Xiameter OFX-5211 fluid is supplied by Univar, Downers Grove, Illinois; Methocels and Kathon LX are supplied by Chempoint, Bellevue, Washington.

Each of the components was tested individually to show that they do not function well individually. (Examples 3-6. not part of the invention)

### Example 3

An aluminum panel was coated with silicon emulsion CHT 1670E at room temperature and was allowed to dry for 30 minutes and was then chilled for 30 minutes in the freezer at −80° C. When the panel was removed from the freezer, water spray was applied. The coating did not totally freeze as part of the coating on the upper part of the panel remained fluid. The emulsion prevented ice forming on the panels.

### Example 4

A mixture of Michem Lube 743 and CHT 1670E was applied to an aluminum panel. The panel was allowed to dry for 30 minutes and then chilled for 30 minutes in the freezer at −80° C. The panel was removed from the freezer. The substrate was not smooth and there was no formulation liquid found on the panel. When water spray was applied, the water beaded up on the surface and no ice was found.

### Example 5

When Q2-5211 was mixed with CHT 1670E without any additional water, the sample thickened instantaneously and was difficult to drawdown. The panel was removed from the freezer and water spray was applied. The film was transparent as opposed to the panels Supra that appeared slightly opaque. Small amounts of ice particles formed on the film, but no covering of ice was found.

### Example 6

An aluminum panel was coated with wax emulsion ML 743 at room temperature and allowed to dry for 30 minutes and then chilled for 30 minutes in the freezer. When the panel was removed from the freezer, water spray was applied. The coating prevented ice forming on the panel. Also, the coating did not totally freeze as was observed by noting that in the upper part of the panel there was fluid.

What is claimed is:

1. An ice release formulation comprising:
A) a nonionic polydimethylsiloxane fluid having a viscosity in the range of 100 cps to 10,000 cps at 25° C.;
B) an organic wax;
C) a surfactant, and,
D) 90 to 10 Weight percent water based on A), B), and C).

2. An ice release formulation as claimed in claim 1 wherein, in addition, said formulation contains a solvent for the components.

3. An ice release formulation as claimed in claim 1 wherein the formulation is in the form of an emulsion.

4. An ice release formulation as claimed in claim 3 wherein said ice release formulation is 10% to 90% solids by weight in said emulsion.

5. An ice release formulation as claimed in claim 3 wherein there are present at least two surfactants.

6. An ice release formulation as claimed in claim 3 wherein, in addition, there is present a viscosity modifier.

7. An ice release formulation as claimed in claim 6 wherein said viscosity modifier is a thickener.

8. An ice release formulation as claimed in claim 7 wherein said thickener is methyl cellulose.

9. An ice release formulation as claimed in claim 8 wherein the methyl cellulose is hydroxy propyl methyl cellulose.

10. An ice release formulation as claimed in claim 5 wherein, in addition, there is a preservative.

11. An ice release formulation as claimed in claim 1 wherein the weight ratio of said polydimethylsiloxane to wax is in the range of 20:80: to 80:20.

12. An ice release formulation as claimed in claim 1 wherein said surfactant is a silicone/glycol copolymer spreading agent.

13. An ice release formulation as claimed in claim 1 wherein said surfactant is present from 0.01 weight percent to 2.0 weight percent based on the amount of polydimethylsiloxane and wax present.

14. An ice release formulation as claimed in claim 5 wherein said surfactants are present from 0.01 to 2.0 weight percent based on the amount of polydimethylsiloxane and wax present.
